(19) United States
(12) Patent Application Publication
(10) Pub. No.: US 2024/0145776 A1
(43) Pub. Date: May 2, 2024

(54) ELECTROLYTE FOR LITHIUM SECONDARY BATTERY AND LITHIUM SECONDARY BATTERY INCLUDING THE SAME

(71) Applicants: KOREA ADVANCED INSTITUTE OF SCIENCE AND TECHNOLOGY, Daejeon (KR); PUSAN NATIONAL UNIVERSITY INDUSTRY-UNIVERSITY COOPERATION FOUNDATION, Busan (KR); KOREA RESEARCH INSTITUTE OF CHEMICAL TECHNOLOGY, Daejeon (KR)

(72) Inventors: Sang Youl KIM, Daejeon (KR); Taehyoung KIM, Daejeon (KR); Jin Hee LEE, Daejeon (KR); Jin Hong LEE, Busan (KR); JaeBin PARK, Busan (KR)

(21) Appl. No.: 18/242,048

(22) Filed: Sep. 5, 2023

(30) Foreign Application Priority Data
Oct. 17, 2022 (KR) 10-2022-0133103

(51) Int. Cl. H01M 10/0567; H01M 10/052; H01M 10/0569

(52) U.S. Cl. CPC H01M 10/0567; H01M 10/052; H01M 10/0569; H01M 2300/0037

(57) ABSTRACT

Provided are a lithium secondary battery electrolyte composition which may effectively suppress a thermal runaway phenomenon, and a lithium secondary battery having excellent electrical properties, life characteristics, and safety by applying the electrolyte composition.

### CROSS-REFERENCE TO RELATED APPLICATIONS

This application claims priority under 35 U.S.C. § 119 to Korean Patent Application No. 10-2022-0133103, filed on Oct. 17, 2022, in the Korean Intellectual Property Office, the disclosure of which is incorporated herein by reference in its entirety.

### TECHNICAL FIELD

The following disclosure relates to an electrolyte for a lithium secondary battery and a lithium secondary battery including the same.

### BACKGROUND

Conventionally, a lithium secondary battery mainly uses a nonaqueous electrolyte using an organic solvent as a main component for securing excellent battery performance such as high voltage, high energy density, and high output, but which volatilizes easily, is highly inflammable, and may cause a side reaction under environments such as high voltage and high temperature, and thus, may cause thermal runaway or has a high risk of ignition. Furthermore, in recent years, as the application scope of a secondary battery is expanded from batteries for small IT electronic devices to medium and large-sized batteries for electric automobiles, a demand for securing heat resistance and safety due to higher capacity and higher output of secondary batteries is growing.

As a solution to the problem, an attempt to apply a new organic electrolyte including an additive for improving thermal stability is continuing. However, the electrolyte additives known so far lack an effect of suppressing thermal runaway and ignition and rather increase interfacial resistance between an electrode and an electrolyte, and become a cause of degrading battery performance such as battery life, capacity, and output characteristics.

Thus, development of a new electrolyte additive which may secure excellent battery performance, effectively suppress thermal runaway, and improve battery safety is required.

### RELATED ART DOCUMENTS

### Patent Documents

(Patent Document 1) Korean Patent Registration Publication No. 10-2310478 (Mar. 24, 2016)

### SUMMARY

An embodiment of the present invention is directed to providing a lithium secondary battery electrolyte composition which may effectively suppress a thermal runaway phenomenon while maintaining excellent long life, high energy density, and high output characteristics of a battery, and a lithium secondary battery having both excellent performance and thermal stability by applying the electrolyte.

In one general aspect, an electrolyte for a lithium secondary battery includes: a lithium salt; a nonaqueous organic solvent; and a polyethersulfone additive having a low critical solution temperature (LCST).

The polyethersulfone may have a number average molecular weight of 3,000 to 20,000 g/mol.

The polyethersulfone may have the low critical solution temperature of 40 to 80° C.

The polyethersulfone additive may be included at 0.01 to 10 wt % based on the total weight of the electrolyte.

The nonaqueous organic solvent may be an ether-based solvent selected from acyclic ethers, cyclic ethers, or combinations thereof.

The acyclic ether may be one or two or more selected from diethyl ether, dipropyl ether, dibutyl ether, dimethoxymethane, trimethoxymethane, dimethoxyethane, diethoxyethane, and dimethoxypropane.

The cyclic ether may be one or two or more selected from dioxolane, methyldioxolane, oxane, dioxane, trioxane, tetrahydrofuran, dihydropyran, tetrahydropyran, methyltetrahydrofuran, furan, and methylfuran.

The lithium salt may be selected from LiPF₆, LiBF₄, LiFSI, LiTFSI, LiSO₃CF₃, LiBOB, and LiDFOB.

The electrolyte for a lithium secondary battery according to an exemplary embodiment may further include a nitric acid-based compound.

The nitric acid-based compound may be selected from lithium nitrate (LiNO₃), lithium nitrite (LiNO₂), nitromethane (CH₃NO₂), and methylnitrate (CH₃NO₃).

In another general aspect, a lithium secondary battery includes: a positive electrode; a negative electrode; the electrolyte for a lithium secondary battery according to an exemplary embodiment; and a separator.

The positive electrode may include sulfur or iron phosphate as a positive electrode active material.

A ratio (Z₂/Z₁) between an interfacial resistance at 60° C. (Z₂) and an interfacial resistance at 25° C. (Z₁) of the battery may be 1.5 or more.

Other features and aspects will be apparent from the following detailed description, the drawings, and the claims.

### BRIEF DESCRIPTION OF THE DRAWINGS

FIG. 1A shows a change in transmittance of the electrolytes according to Example 1 depending on temperature.

FIG. 1B shows a change in transmittance of the electrolytes according to Example 2 depending on temperature.

FIG. 2A shows results of measuring cycle behavior of the batteries according to Comparative Example 1 depending on current density at room temperature.

FIG. 2B shows results of measuring cycle behavior of the batteries according to Example 1 depending on current density at room temperature.

FIG. 3A shows results of confirming cycle performance of the batteries according to Comparative Example 1 depending on temperature.

FIG. 3B shows results of confirming cycle performance of the batteries according to Example 1 depending on temperature.

FIG. 4A shows results of measuring interfacial resistance of the batteries according to Comparative Example 1 depending on temperature.

FIG. 4B shows results of measuring interfacial resistance of the batteries according to Example 1 depending on temperature.

FIG. 5 shows results of measuring discharge capacities by current density of the battery according to Example 2.

FIG. 6 shows results of measuring discharge capacities by current density of the battery according to Example 4.

FIG. 7 shows results of measuring discharge capacities by current density of the battery according to Example 3.

### DETAILED DESCRIPTION OF EMBODIMENTS

Hereinafter, the present invention will be described in detail so as to be easily practiced by a person skilled in the art to which the present invention pertains. However, the present disclosure may be implemented in various different forms and is not limited to the implementations described herein. In addition, it is not intended to limit the protection scope defined in the claims.

In addition, technical terms and scientific terms used in the description of the present invention have the general meaning understood by a person skilled in the art unless otherwise defined, and description for the known function and configuration obscuring the present invention will be omitted in the following description.

The numerical range used in the present specification includes all values within the range including the lower limit and the upper limit, increments logically derived in a form and span in a defined range, all double limited values, and all possible combinations of the upper limit and the lower limit in the numerical range defined in different forms. Unless otherwise defined in the specification of the present invention, values which may be outside a numerical range due to experimental error or rounding of a value are also included in the defined numerical range.

Unless otherwise particularly defined in the present invention, “comprising” any elements will be understood to imply further inclusion of other elements rather than the exclusion of any other elements. In addition, the singular form used in the specification and claims appended thereto may be intended to also include a plural form, unless otherwise indicated in the context.

Hereinafter, the present invention will be described in detail.

An exemplary embodiment of the present invention may provide a lithium secondary battery which may effectively suppress a thermal runaway phenomenon due to a rapid current increase while also maintaining excellent characteristics such as life, energy density, and output, by using a specific electrolyte composition.

The electrolyte according to an exemplary embodiment is characterized by including a lithium salt; a nonaqueous organic solvent; and a polymer additive having a low critical solution temperature (LCST), for example, a polyethersulfone additive having LCST.

The polymer having a low critical solution temperature (LCST) refers to a material which is mixed well with a solvent and forms a homogeneous phase below a specific temperature, and undergoes reversible sol-gel phase transition to be solidified at a specific temperature or higher. That is, when a polymer having LCST is used as an additive of an electrolyte, the polymer agglomerated at a temperature equivalent to or higher than LCST decreases ion transport and is adsorbed on an electrode surface, thereby effectively suppressing a thermal runaway phenomenon due to a rapid current increase.

The polyethersulfone according to an exemplary embodiment may show LCST behavior by specific means, for example, the number average molecular weight of polyethersulfone, the kind of solvent, or a combination thereof, and the electrolyte according to an exemplary embodiment may provide a lithium secondary battery satisfying both excellent performance and thermal stability, by using the polyethersulfone showing LCST behavior as an electrolyte additive.

Specifically, the polyethersulfone may include a repeating unit represented by the following Chemical Formula 1:

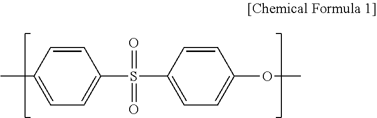

As an example, the polyethersulfone may have a number average molecular weight of 3,000 to 20,000 g/mol, 3,000 to 10,000 g/mol, or 3,000 to 7,000 g/mol. In the case of satisfying the molecular weight, when combined with other electrolyte constituents, the phase transition of polyethersulfone may occur in a more appropriate temperature range, and the thermal runaway phenomenon of a battery may be more effectively suppressed.

In the electrolyte according to an exemplary embodiment, the polyethersulfone may have a low critical solution temperature of 40 to 100° C., 40 to 80° C., 50 to 80° C., or 50 to 70° C.

As an example, the polyethersulfone additive may be included at 0.01 to 10 wt %, 0.01 to 5 wt %, 0.1 to 3 wt %, or 0.1 to 1 wt %, based on the total weight of the electrolyte. Within the range, the effect desired in the present invention, that is, the effect of improving both performance and thermal stability of a lithium secondary battery is more remarkable without impairing stability of a formulation.

In the electrolyte according to an exemplary embodiment, the nonaqueous organic solvent is not limited as long as polyethersulfone may show LCST behavior therein, but, for example, may be an ether-based solvent selected from acyclic ethers, cyclic ethers, or combinations thereof.

The acyclic ether may be, for example, one or two or more selected from diethyl ether, dipropyl ether, dibutyl ether, dimethoxymethane (DMM), trimethoxyethane (TMM), dimethoxyethane (DME), diethoxyethane (DEE), and dimethoxypropane (DMP), and specifically dimethoxyethane, but is not limited thereto.

The cyclic ether may be, for example, one or two or more selected from dioxolane (DOL), methyldioxolane, oxane, dioxane, trioxane, tetrahydrofuran (THF), dihydropyran (DHP), tetrahydropyran (THP), methyltetrahydrofuran, furan, and methyl furan, and specifically dioxolane, but is not limited thereto.

Specifically, the nonaqueous organic solvent may be a combination of an acyclic ether-based solvent and a cyclic ether-based solvent, and for example, may be a combination of dimethoxyethane and dioxolane.

More specifically, the nonaqueous organic solvent may be a mixture of the acyclic ether-based solvent and the cyclic ether-based solvent at a volume ratio of 3:7 to 7:3 or a volume ratio of 4:6 to 6:4. When a solvent satisfying the ratio is used, the thermal runaway phenomenon of a battery may be more effectively suppressed. In the case of using a nonaqueous organic solvent satisfying the ratio, when combined with other electrolyte constituents, the phase transition of polyethersulfone may occur in a more appropriate temperature range, and the thermal runaway phenomenon of a battery may be more effectively suppressed.

In the electrolyte according to an exemplary embodiment, the lithium salt is not particularly limited as long as it is commonly used in the art, but for example, may be one or two or more selected from LiPF₆, LiBF₄, LiFSI, LiTFSI, LiSO₃CF₃, LiBOB, and LiDFOB.

A concentration of the lithium salt may be 0.1 to 2.0 M or 0.5 to 1.5 M. When the range is satisfied, the conductivity of the electrolyte may be better.

The electrolyte according to an exemplary embodiment may further include an additive for stabilization. As the additive, a nitric acid or nitrous acid-based compound may be further included. The nitric acid or nitrous acid-based compound shows an effect of forming a stable coat on a lithium electrode and improving charge/discharge efficiency. The nitric acid or nitrous acid-based compound is not particularly limited in the present invention, but may be one or two or more selected from the group consisting of inorganic nitric acid or nitrous acid-based compounds such as lithium nitrate (LiNO₃), potassium nitrate (KNO₃), cesium nitrate (CsNO₃), barium nitrate (Ba(NO₃)₂), ammonium nitrate (NH₄NO₃), lithium nitrite (LiNO₂), potassium nitrite (KNO₂), cesium nitrite (CsNO₂), and ammonium nitrite (NH₄NO₂); organic nitric acid or nitrous acid-based compounds such as methyl nitrate, dialkyl imidazolium nitrate, guanidine nitrate, imidazolium nitrate, pyridinium nitrate, ethyl nitrite, propyl nitrite, butyl nitrite, pentyl nitrite, and octyl nitrite; organic nitro compounds such as nitromethane, nitropropane, nitrobutane, nitrobenzene, dinitrobenzene, nitropyridine, dinitropyridine, nitrotoluene, and dinitrotoluene, and combinations thereof.

The additive may be included at a concentration of 0.01 to 1 M, 0.01 to 0.5 M, or 0.05 to 0.5 M, but is not limited thereto.

In addition, the electrolyte according to an exemplary embodiment may further include other components for improving the function, if necessary, in addition to the components described above. Other components may include, for example, an overcharge prevention agent, a dehydrating agent, a deoxidizing agent, and an auxiliary for improving properties for improving capacity retention properties and cycle properties after preservation at a high temperature, which are commonly known in the art.

In addition, another exemplary embodiment of the present invention provides a lithium secondary battery including a positive electrode; a negative electrode; the electrolyte for a lithium secondary battery; and a separator.

The lithium secondary battery manufactured from the electrolyte according to an exemplary embodiment has excellent characteristics such as life, energy density, and output, and also has an excellent effect of suppressing a thermal runaway phenomenon and an ignition phenomenon.

As an example, the lithium secondary battery manufactured from the electrolyte according to an exemplary embodiment may have a ratio (Z₂/Z₁) between an interfacial resistance at 60° C. (Z₂) and an interfacial resistance at 25° C. (Z₁) of 1.5 or more, 1.3 or more, or 1.0 or more and 3.0 or less or 2.0 or less. That is, the lithium secondary battery employing the electrolyte according to an exemplary embodiment has resistance greatly increasing with a rise in temperature to degrade electrochemical performance and secure thermal runaway safety.

The positive electrode includes a positive electrode active material which may adsorb and desorb lithium ions. The positive electrode active material is not particularly limited as long as it is commonly used in the art, but, for example, may include at least one selected from the group consisting of lithium cobalt oxides, lithium manganese oxide, lithium manganese-nickel-cobalt composite oxides, lithium metal oxides, lithium iron phosphate, sulfur, oxygen, and lithium nickel manganese oxides. More specifically, the lithium secondary battery according to an exemplary embodiment may be a lithium-sulfur (Li—S) battery including sulfur as a positive electrode active material or a lithium iron phosphate (LFP) battery including lithium iron phosphate as a positive electrode active material.

The negative electrode and the separator may be those commonly used in a lithium secondary battery, and the shape of the lithium secondary battery according to an exemplary embodiment is not particularly limited as long as the positive electrode, the negative electrode, the separator, and the electrolyte composition described above may be stored, and may be, for example, cylindrical, coin, pouch, flat, laminated shapes, and the like.

Hereinafter, the exemplary embodiments described above will be described in detail through the following examples. However, the following examples are only for description, and do not limit the right scope.

The physical properties of the examples were measured as follows:

(1) Number Average Molecular Weight

It was measured using gel permeation chromatography (GPC). As a column, one PSS GRAM column having a molecular weight range of 300-60,000 g mol⁻¹ and two PSS GRAM columns having a molecular weight range of 10,000-50,000,000 g mol⁻¹ were connected. Polystyrene as a standard sample and N,N-dimethylformamide including a 0.05 M lithium bromide salt as a solvent were used, and a sample at a concentration of 10 mg/10 mL was prepared under the conditions of a temperature of 45° C. and a flow rate of 1.0 mL/min and was supplied in an amount of 200 μL to perform measurement.

<Preparation of Polyethersulfone>

### Preparation Example 1

A 4-(4-fluorophenylsulfonyl)phenol potassium salt (3.000 g, 17.22 mmol) was added to a 50 mL three-neck round bottom flask equipped with a dean-stark trap and a condenser. The solid was dissolved in a dimethylsulfoxide (DMSO)/benzene mixed solvent. A yellow mixture obtained by the dissolution was vigorously stirred at 80° C. until water was removed by azeotropic distillation. Thereafter, the reaction mixture was heated to 160° C. to remove residual benzene, and the temperature was maintained for 2 hours and 40 minutes and then cooled to room temperature. The mixture was precipitated in methanol containing hydrochloric acid, and the remaining solvent was removed under heated vacuum conditions to prepare a white powdery polyethersulfone (PES) polymer of Preparation Example 1. The number average molecular weight measured using gel chromatography (GPC) was 5,000 g/mol.

### Preparation Example 2

A polyethersulfone (PES) polymer of Preparation Example 2 was prepared in the same manner as in Preparation Example 1, except that the time to maintain the temperature at 160° C. was increased to 3 hours. The number average molecular weight measured using gel chromatography (GPC) was 4,200 g/mol.

### Example 1

Preparation of Electrolyte

0.7M LiTFSI and 0.05M LiNO₃ were dissolved in a mixed solvent of dioxolane (DOL) and dimethoxyethane (DME) at a volume ratio of 1:1 to prepare a mixed solution. The polyethersulfone of Preparation Example 1 was dissolved at 2 wt % in the mixed solution to prepare the electrolyte of Example 1.

Manufacture of Positive Electrode

During the manufacture of a positive electrode, a sulfur-ketjen black composite as a positive electrode active material, polyvinylidene fluoride (PVdF) as a binder, and Super P as a conductive material at a weight ratio of 7:1:2 were dispersed in N-methyl-2-pyrrolidone (NMP) as a solvent to prepare a positive electrode slurry. The slurry was coated on an aluminum foil having a thickness of 30 μm and dried at a temperature of 60° C. to manufacture a positive electrode having a loading level of about 1.0 mg/cm².

Manufacture of Battery

A lithium metal foil having a size of 14n was used as a negative electrode, a polypropylene film having a thickness of 20 μm was used as a separator, and 40 μl of the electrolyte prepared in Example 1 was injected to manufacture a coin-cell type battery.

### Example 2

The electrolyte of Example 2 was prepared in the same manner as in Example 1, except that PES of Preparation Example 2 was used instead of PES of Preparation Example 1 during preparation of the electrolyte, the concentration of PES was 1 wt %, and 1 M LiBF₄ was used instead of 0.7 M LiTFSI.

In addition, the battery of Example 2 was manufactured in the same manner as in Example 1, except that a positive electrode manufactured by dispersing LiFePO₄ (LFP) as a positive electrode active material, polyvinylidene fluoride (PVdF) as a binder, and Super P as a conductive material at a weight ratio of 8:1:1 in a solvent was used.

### Example 3

The electrolyte and the battery of Example 3 were manufactured in the same manner as in Example 1, except that during preparation of the electrolyte, PES was used at 0.3 wt % and 0.8 M LiTFSI was used.

### Example 4

The electrolyte and the battery of Example 4 were manufactured in the same manner as in Example 3, except that LiNO₃ was not added.

### Comparative Example 1

The electrolyte of Comparative Example 1 was prepared in the same manner as in Example 1, except that during preparation of the electrolyte, polyethersulfone was not added.

### Experimental Examples

Evaluation 1. Analysis of Transmittance Depending on Temperature

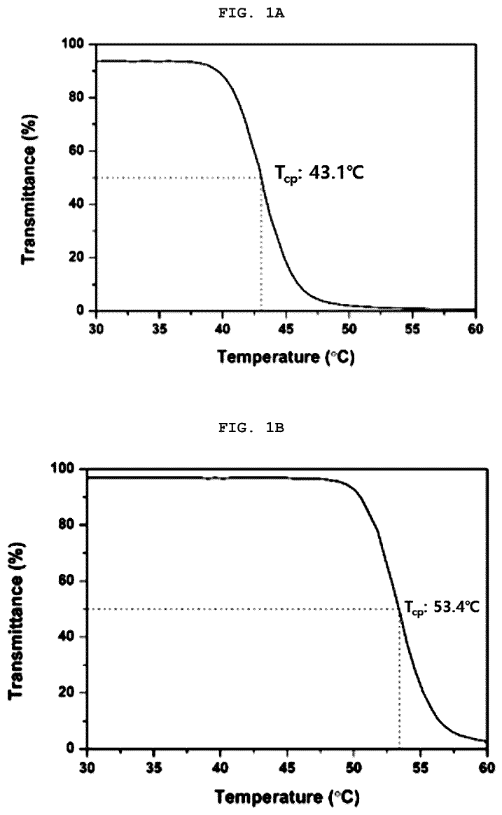

UV-vis spectrometry (Shimizu UV-2600 equipment equipped with a temperature control module, an absorption wavelength of 600 nm) was used to observe a change in transmittance depending on a temperature rise of the electrolytes prepared in Examples 1 and 2, and the phase separation behavior of the solutions was analyzed. As shown in FIG. 1A and FIG. 1B, it was confirmed that the electrolytes of Examples 1 and 2 showed a phase separation phenomenon with a temperature rise, and had transmittances at 43.1° C. and 53.4° C. decreased by 50% from initial values, respectively. That is, it was found that the polyethersulfone in the electrolytes of Examples 1 and 2 had a low critical solution temperature (LCST).

Evaluation 2. Evaluation of Cycle Behavior Depending on Current Density at Room Temperature

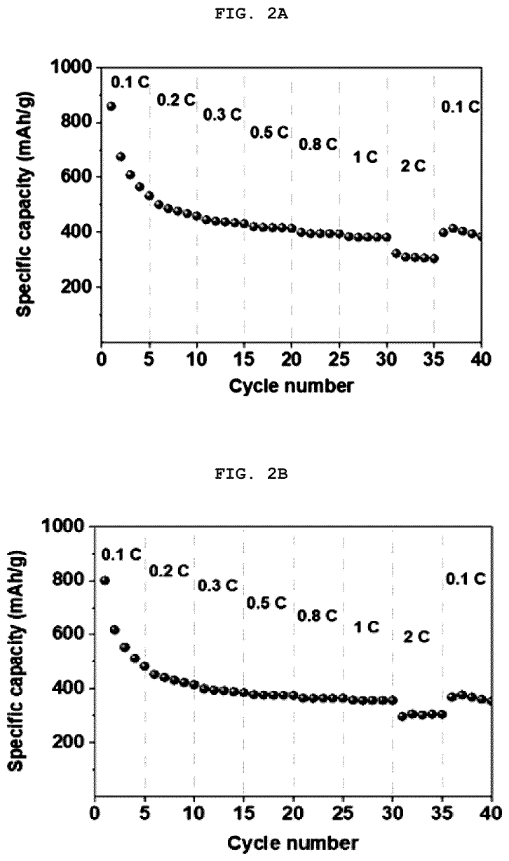

In order to evaluate the charge/discharge behavior of the lithium-sulfur batteries manufactured in Example 1 and Comparative Example 1 at room temperature (25° C.), a charge/discharge cycle was performed 5 times each at C-rates of 0.1 C, 0.2 C, 0.3 C, 0.5 C, 1 C, and 2 C in a voltage range of 1.8 to 2.8 V, thereby measuring the capacity of the batteries. Referring to FIG. 2A and FIG. 2B, in both batteries including the electrolytes prepared in the example and the comparative example, similar capacity values were measured at each C-rate. In addition, in both batteries, two flat voltage areas developed in the discharge process and one flat voltage area developed in the charge process were similarly observed. That is, it was found that the battery of the example including the polyethersulfone additive for improving thermal runaway stability may operate stably at room temperature and may implement excellent capacity and output characteristics.

Evaluation 3. Evaluation of Battery Performance Depending on Temperature

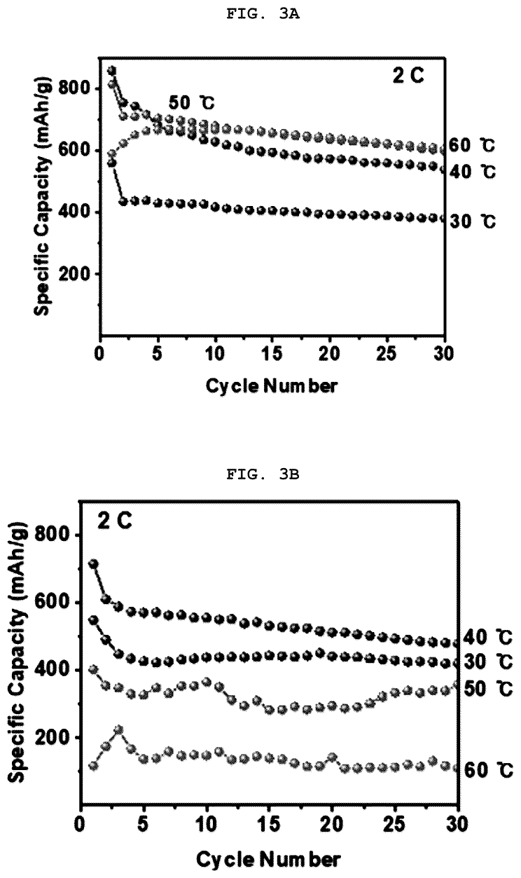

In order to evaluate the performance of the batteries manufactured in Example 1 and Comparative Example 1 depending on temperature, cycle stability was measured under a C-rate condition of 2 C. As shown in FIG. 3A, the battery according to the example had a reversible capacity increased with a temperature rise from 30° C. to 40° C., but had a reversible capacity decreased with a temperature rise to 50° C., and showed a low reversible capacity of about 200 mAh/g at 60° C. due to a rapid capacity decrease.

Evaluation 4. Evaluation of Interfacial Resistance of Battery Depending on Temperature

An impedance spectroscope (SP-150, Bio-Logic Co.) was used to evaluate the interfacial resistance of the batteries of Example 1 and Comparative Example 1 depending on temperature.

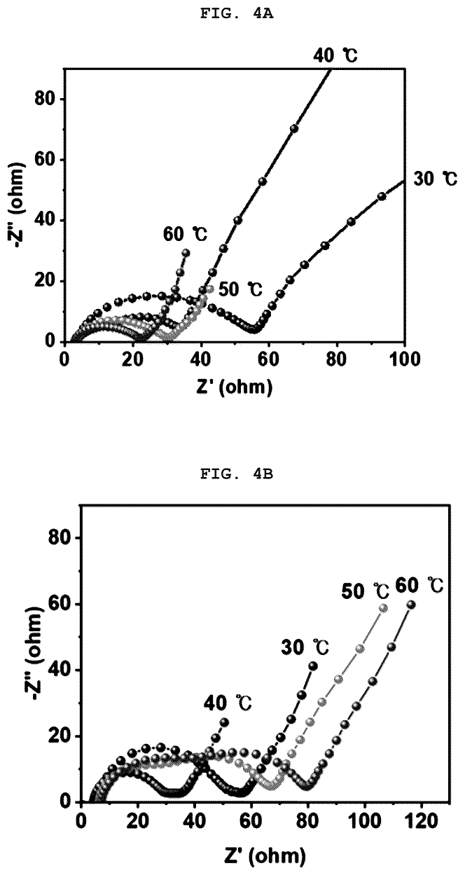

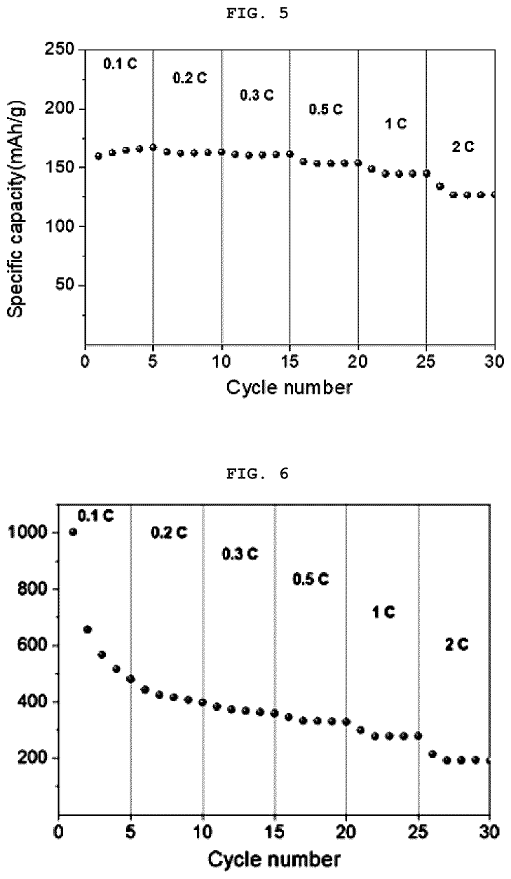

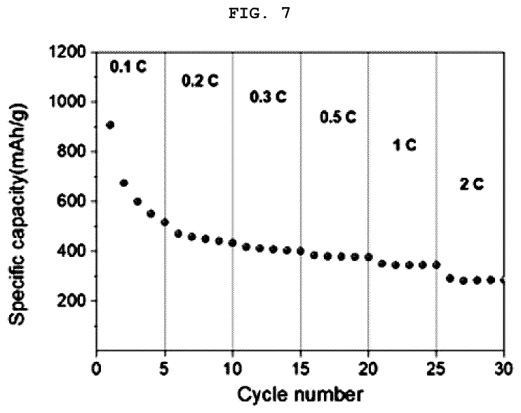

Referring to FIG. 4B, interfacial resistance of the battery was measured after operating the battery manufactured in example 1 for 30 cycles, and the results of decreased resistance when the temperature was raised from 30° C. to 40° C., but rather greatly increased resistance when the temperature was raised to 60° C. were shown, and this was consistent with the result of deteriorating electrochemical performance at the corresponding temperature.

That is, by including polyethersulfone having LCST, the electrolyte according to the present invention may secure all of the thermal runaway safety, long life, high energy density, and high output characteristics of a battery employing the electrolyte.

Since the electrolyte for a lithium secondary battery according to an exemplary embodiment of the present invention includes a polyethersulfone additive having LCST, a lithium secondary battery implementing excellent battery performance and thermal stability may be provided. Specifically, though the electrolyte according to an exemplary embodiment includes an additive for improving thermal stability, a thermal runaway phenomenon and an ignition phenomenon may be effectively suppressed even in a low temperature range while the electrical properties and the life characteristics of a lithium secondary battery are maintained excellently.

In addition, since the polyethersulfone additive according to an exemplary embodiment may be prepared in an economical and easy manner, it is advantageous for practical application to industry.

That is, the electrolyte according to an exemplary embodiment of the present invention may improve the thermal stability problem of a conventional lithium secondary battery and provide a lithium secondary battery which may satisfy all of electrical properties, life characteristics, safety, and productivity.

Hereinabove, although the present invention has been described by specific exemplary embodiments, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

What is claimed is:

1. An electrolyte for a lithium secondary battery comprising: a lithium salt; a nonaqueous organic solvent; and a polyethersulfone additive having a low critical solution temperature (LCST).

2. The electrolyte for a lithium secondary battery of claim 1, wherein the polyethersulfone has a number average molecular weight of 3,000 to 20,000 g/mol.

3. The electrolyte for a lithium secondary battery of claim 1, wherein the polyethersulfone has the low critical solution temperature of 40 to 80° C.

4. The electrolyte for a lithium secondary battery of claim 1, wherein the polyethersulfone additive is included at 0.01 to 10 wt % based on the total weight of the electrolyte.

5. The electrolyte for a lithium secondary battery of claim 1, wherein the nonaqueous organic solvent is an ether-based solvent selected from acyclic ethers, cyclic ethers, or combinations thereof.

6. The electrolyte for a lithium secondary battery of claim 5, wherein the acyclic ether is one or two or more selected from diethyl ether, dipropyl ether, dibutyl ether, dimethoxymethane, trimethoxymethane, dimethoxyethane, diethoxyethane, and dimethoxypropane.

7. The electrolyte for a lithium secondary battery of claim 5, wherein the cyclic ether is one or two or more selected from dioxolane, methyldioxolane, oxane, dioxane, trioxane, tetrahydrofuran, dihydropyran, tetrahydropyran, methyltetrahydrofuran, furan, and methylfuran.

8. The electrolyte for a lithium secondary battery of claim 1, wherein the lithium salt is selected from LiPF₆, LiBF₄, LiFSI, LiTFSI, LiSO₃CF₃, LiBOB, and LiDFOB.

9. The electrolyte for a lithium secondary battery of claim 1, further comprising a nitric acid-based compound.

10. The electrolyte for a lithium secondary battery of claim 9, wherein the nitric acid-based compound is selected from lithium nitrate (LiNO₃), lithium nitrite (LiNO₂), nitromethane (CH₃NO₂), and methylnitrate (CH₃NO₃).

11. A lithium secondary battery comprising: a positive electrode; a negative electrode; the electrolyte for a lithium secondary battery of claim 1; and a separator.

12. The lithium secondary battery of claim 11, wherein the positive electrode includes sulfur or iron phosphate as a positive electrode active material.

13. The lithium secondary battery of claim 11, wherein a ratio (Z₂/Z₁) between an interfacial resistance at 60° C. (Z₂) and an interfacial resistance at 25° C. (Z₁) of the battery is 1.5 or more.
